(19) United States
(12) Patent Application Publication
(10) Pub. No.: US 2007/0282927 A1
(43) Pub. Date: Dec. 6, 2007

(54) Method and apparatus to handle changes in file ownership and editing authority in a document management system

(76) Inventor: Igor Polouetkov, Conyers, GA (US)

Correspondence Address: Lawrence Harbin & Timothy Klima, 500 9th Street SE, Washington, DC, 20003, US

(21) Appl. No.: 11/443,080

(22) Filed: May 31, 2006

(51) Int. Cl. G06F 7/00; G06F 17/30

(52) U.S. Cl. 707/204; 707/102

(57) ABSTRACT

A method and corresponding system to maintain an updated version of an electronic file in a multi-user document management system. The system includes a master node and at least one satellite node to enable satellite offices of an enterprise to communicate over a network with a central file store. The method includes providing a central file store on the network to store a commonly accessible shared file, providing ownership information that identifies an owner of the file, enabling the owner of the file to authorize changes to the file, replicating the changes at the central file store, enabling the owner to transfer ownership of the file by altering the ownership information to identify a subsequent owner that controls changes to the file, and providing shared access to the file by the satellite nodes to thereby maintain an updated version of the file for multiple users of the document management system. The owner of the file preferably is the master node or one of the satellite nodes. Other aspects include the master node handling ownership transfers and file transfers with the central file store; enabling read-only access to the file when the owner is off-line, and enabling a file owner to change the file while off-line and then replicating the change upon re-establishment of connection with said network.

### BACKGROUND

This invention relates to document management, but more specifically, to a method and a system to handle editing, access, and/or ownership of shared files in a multi-user document management environment.

High availability of updated electronic files and other information is a critical requirement of a modern day enterprise. When the enterprise has multiple geographically located offices, deployment of distributed satellite servers or “nodes” is common. Satellite nodes provide local access to central files by individual users situated at remote offices. In a multi-user environment, obtaining the most recent or updated version of a document file becomes problematic, particularly when editing authority or ownership may be transferred among several users or nodes, or when a remote user edits a document file when his satellite node is off-line and subsequently comes on-line with the updated document file. During work flow processing, for example, a user at a remote office frequently desires to access the most current version of a file, even if only in a read-only mode. In a read-only mode, files may be viewed or rendered but no changes can be made. There are, however, many circumstances requiring editing of a file (e.g., annotating, modifying, deleting, or creation/importation) by multiple owners or authors. This is typically done by transferring ownership of the file to another node or user but, in order to maintain file integrity so that the most current version is available over the network, the authority to change a file is generally restricted to a single site at any given time.

Prior document management systems have employed an ownership mechanism to control operations of an individual user with respect to a file. In U.S. Pat. No. 6,775,665 (col. 10), for example, files are marked with an ownership property to control access, copying and deletion relative to a document. Provision is also made for changing ownership to another individual user. Other document management systems, such as those disclosed by U.S. Pat. Publications 2003/0046351 (¶¶103, 111) and 2004/0179224 (¶56), provide an indicia that defines the level of authority given to respective users, such as the authority to view, edit, delete a file. These systems, however, fall short of automatically maintaining an updated version of a shared document file on a network and/or providing a mechanism to automatically (and transparently) negotiate ownership control so as to enable authorized changes to a file by any one of multiple users located on different nodes of a network during work flow processing.

### SUMMARY OF THE INVENTION

According to a first embodiment of the invention, there is provided a method of maintaining an updated version of a shared file in a multi-user document management system having a master node and at least one satellite node that communicate over a network. The method comprises the steps of providing a central file storage on the network to store a commonly accessible file, providing ownership information that identifies an owner of the file, enabling the owner to authorize changes to the file according to the ownership information, replicating the changes to the file at the central file storage, enabling the owner to transfer ownership of the file by altering the ownership information to identify a subsequent owner that may authorize changes to the file, and providing shared access to the file via a satellite node communicating over the network with the central file storage. In an exemplary implementation, the owner of the file is the master node or the satellite node, each of which may serve individual users. Changes to the file may include editing, annotating, deletion, importation, creation, or other operation relative to the file.

Other aspects of the method include providing a master node to handle file transfers with the central file storage; providing a master node to handle negotiation for file ownership between a current owner and a subsequent owner; enabling read-only access to the file when the owner is unavailable to participate in negotiation for ownership transfer of the file, and enabling a file owner to authorize changes to said file while off-line and to replicate the changes upon re-establishment of connection with said network.

According to another embodiment of the invention, there is provided a method of transferring ownership and editing authority of a file over a network in a multi-user document management system, which comprises providing over the network shared access to a file having associated ownership indicia that identifies the owner of the file and whether file ownership may be transferred, enabling an owner to permit changes to the file, transferring ownership and editing authority relative to the file to another owner according to the ownership indicia, and replicating changes to the file at a central file store located on the network.

In yet another embodiment of the invention, there is provided a document management system to maintain an updated version of a shared document file accessible by multiple users over a network wherein the system comprises a central file store that stores a document file having associated ownership indicia identifying the owner of the file; at least one satellite node to enable a user on the network to communicate with the central file store in order to store and retrieve files; and a processor that includes an editing module to enable changes to the file according to ownership indicia, a replicator module to replicate changes in a corresponding file at the central file store, a negotiator module to enable a transfer of file ownership or editing authority; and an access coordinator to enable access to the file via the network.

Other aspects of the system include the ownership indicia further indicating whether ownership may be freely transferred, wherein the negotiator module responds to the indicia to transparently transfer file ownership to a subsequent owner desiring ownership and/or editing authority. Additional aspects include the master node handling ownership transfer negotiation; the central file store being located at a master node that handles access to the file store by the satellite nodes; the master node permitting read-only access to the shared file when the file owner is off-line or when ownership transfer is not permitted; ownership indicia being stored among attributes of the file; the ownership indicia being provided by an ownership records database maintained at the central file store; the editing module enabling changes to the file while the owner is off-line and the replicator module replicating the changes upon re-establishment of network connection; and the replicator module automatically and periodically replicating changes to the file at the central file store.

Other aspects of the invention will become apparent upon review of the following detailed description taken in connection with the accompany drawings. The invention, though, is pointed out with particularity by the appended claims.

### BRIEF DESCRIPTION OF THE DRAWINGS

FIG. 1 is a system diagram that illustrates an embodiment of a document management system that provides ownership transfer of a document file according to an aspect of the present invention.

FIG. 2 is a flow diagram generally depicting a method of maintaining an updated version of a shared document in a multi-user environment according to another embodiment of the present invention.

### DESCRIPTION OF ILLUSTRATIVE EMBODIMENTS

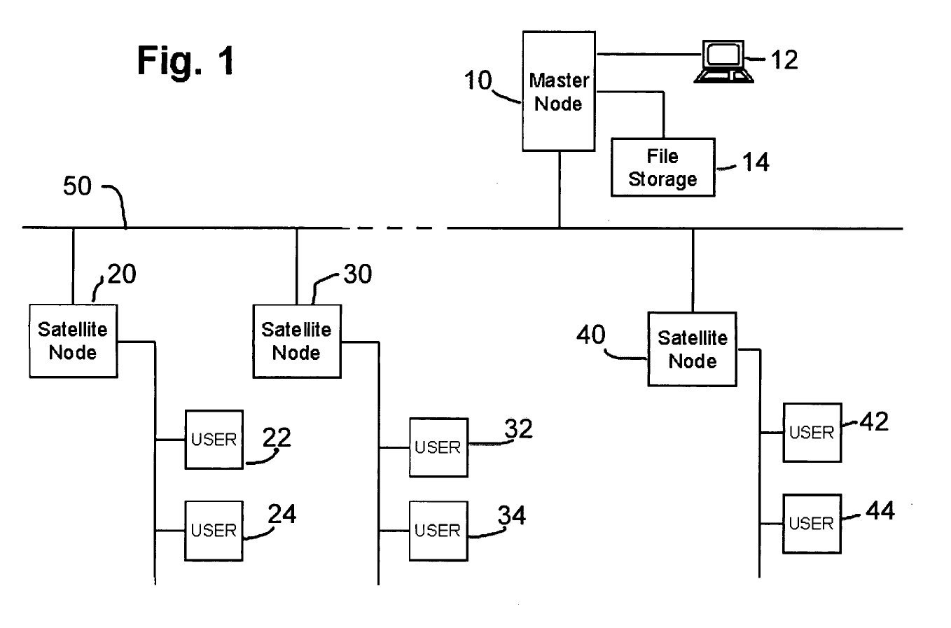

FIG. 1 depicts an architectural arrangement of a multi-user document management system that manages or maintains current or updated versions of a file when multiple users may be authorized to make changes to the file. The system includes a master node 10 residing at a central location of an enterprise and one or more satellite nodes 20, 30, and 40 that reside at branch offices of the enterprise. Satellite nodes 20, 30, and 40 serve respective users 22, 24, 32, 34, 42, and 44 of the remote satellite offices where a user may wish to transfer (upload or download) files with a central file storage 14. Each of the nodes 10, 20, 30, and 40 includes data processing devices or servers that manage, store, and/or effect transfer of files and other information locally or remotely via a network 50. Nodes 20, 30, and 40 serve as host for the individual users. Network 50 may comprise wired or wireless connections with the nodes, e.g., via a LAN, WAN, Internet, or other communication link using conventional interfaces and protocols.

In a typical implementation of the invention, files comprising electronic document files or images thereof are grouped and stored in central file storage device 14 of node 10. A file in the realm of managing paper documents may include folders, documents, pages, etc. Since an electronic file may include multiple documents, the size of the file can be large. Hence, the process of transferring a file and/or file ownership within the system contains multiple steps and can be restored in case of failure. Storage device 14, which stores the electronic files, includes a conventional mass storage device such as a magnetic or optical storage drive. During work flow processing an owner of a file may, on an ongoing basis, authorize updating, editing, or annotating of the file, which file may then be made available to an administrator via terminal 12 or to any of the users situated at the satellite nodes. The file may also be deleted. In the illustrated implementation, the owner may be the master node 10 or any of the satellite nodes 20, 30, or 40. File ownership may also be transferred among nodes, which, in turn, permits file access by and editing authority to the individual users. Ownership transfer is the process of transferring the latest copy of an electronic file from central storage 14 along with the right of another node to authorize changes to the file. A file may also be created or imported by a user or the administrator, and then placed in the central file storage 14 by a node for subsequent retrieval by others over the network.

According to an aspect of the present invention, each file in central file storage 14 has an associated tag, marker, or attribute that identifies the “owner” of the file. A node where a file is created or imported into the document management system, or the node where the most frequent access to a file is needed, is generally deemed the “owner,” but other ownership rules may also be arranged. Ownership information is thus reflected in the associated tag, marker or attribute. The owner of a file has all privileges with respect to the file; including editing, deleting, annotating, or making any other change. Without ownership or authority, other nodes may only enable access to the file in read-only mode.

Ownership information may, for example, be reflected in the attributes of the file, or alternatively, in an ownership records database maintained elsewhere in the system, such as in file storage 14.

To illustrate determination of ownership, a Texas branch of an enterprise may scan and store paper documents; an offshore branch in India may scan and store paper documents pre-shipped from the Texas branch (or elsewhere by authority of the Texas branch); and employees at the Texas branch may retrieve, process, and work with the scanned documents. In both cases, the Texas node (or an individual user thereof) is considered the “owner” of the electronic file. Employees at other locations of the enterprise may view the documents but may not change files owned by the Texas office unless authorization is provided by the file owner. Authorization to change a file is negotiated between nodes via the master server 10, which includes a set of program instructions to implement such negotiation. Otherwise, users at other locations have read-only access to the document files even when the Texas satellite node is offline (e.g., disconnected from master node 10) and no change authorization may be negotiated. In the illustrated embodiment, negotiation for ownership is performed by data processing devices of the users at respective ends of the network.

Master node 10 provides access coordination and enables ownership negotiation between and among satellite nodes 20, 30, 40 to transfer files with central content repository 14. The current owner node (which may also be the master node), the node requesting ownership, and the access coordinator (i.e., the master node) are involved in an ownership transfer process. Each must be on-line in order to carry out an ownership negotiation process. In addition, when the owner of a file enables changes, edits, updates, importation, or deletion of a file, the satellite node effects replication of the change in (or deletion of) the corresponding file at the central file storage 14. Rather than the satellite node effecting replication, server node 10 may include program instructions to “poll” the satellite node for recent changes in corresponding files at central file storage, and then replicate those changes in the corresponding file stored in central file storage 14. A typical implementation of a multi-user document management system, however, includes server-side and client-side program instructions operating in a collaborative way to ensure that central file storage 14 maintains the most recent or updated version of a file that is commonly shared over the network. Advantageously, all employees of the enterprise are ensured at least read-only access to all of the latest versions of electronic files via their respective nodes.

If, for example, a change is sought to be made by user 22 while satellite node 20 is “off line,” satellite node 20 will replicate the change in file storage 14 as soon as network connection is re-established between satellite node 20 and master server 10. Replication is preferably effected by satellite node 20, transparently to the individual user so that no action is individually required by that user. When an “owner” satellite node is offline (e.g., disconnected from the network) from the master node thereby inhibiting replication of a pending file change at central file storage 14, master node 10 implements program instructions to serve (i.e., retrieve and transfer a file) other users with the most recently available copy of the file stored in file storage 14. In this case, the file is made available only in a read-only mode since negotiation for ownership control cannot be made. By a status message or other means, the user is notified by satellite node 20 that the file is being made available in read-only mode.

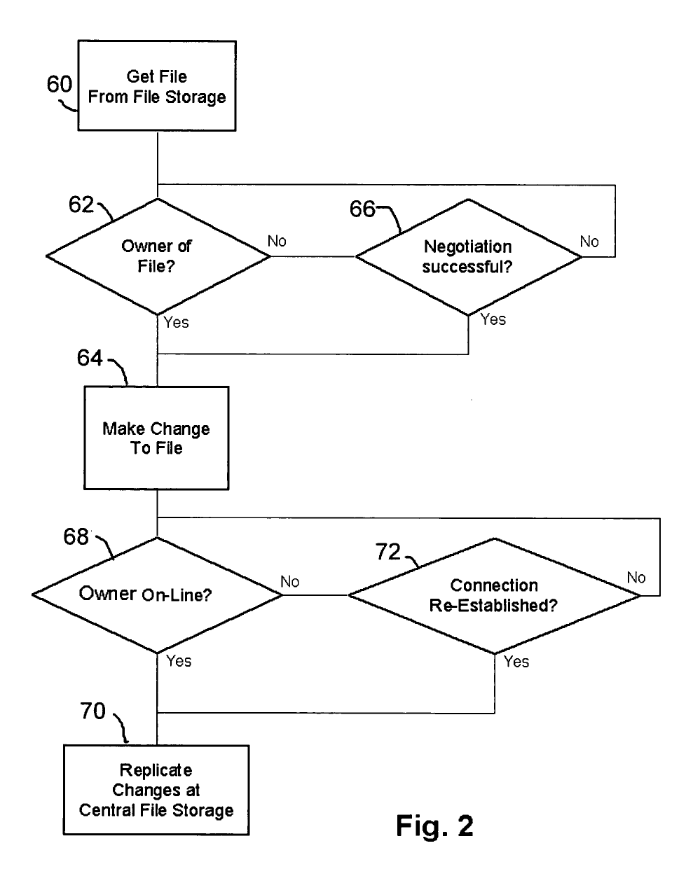

FIG. 2 illustrates a method of accessing and/or editing a file according to another aspect of the present invention. At step 60, a node, e.g., a local satellite node serving individual users at a remote office of an enterprise, executes conventional program instructions to retrieve a document file from central storage. Along with the electronic file, the node obtains file ownership information, which may be part of the retrieved file or obtained from an ownership records database, as previously explained. Based on the ownership information, the node is queried at step 62 whether the node owns the file. Querying the ownership information is transparent to the user and may be performed locally by the satellite node, by the master node, or collaboratively by both satellite and master nodes. If the result of the query is affirmative, then at step 64 a user by authorization of the node is permitted to edit or change the retrieved file. If the result of the query was negative, the node at step 66 negotiates for ownership and/or authority to enable editing or changes to the retrieved file. If the negotiation is successful, the node at step 64 enables editing or changes to the retrieved document file by a user. Requests for ownership transfer or editing authority is preferably transparent to the user so that no action is required by an individual human user. In other words, program instructions in satellite node (or the individual user's terminal) may interact with program instructions in the master node to effect negotiation with the file owner for authority to make changes to the file. If negotiation for authority to change the file was unsuccessful, such as when the file owner node is off-line or where the file owner node is on-line but declines to grant the authority, the routine loops back to step 62 and the user may only view or render the file.

Assuming the node has authority to permit editing of the retrieved file; the method continues at step 68 where a query is made concerning the on-line status, e.g., network connectivity, of the node via a satellite node network connection with the master node. If the node is on-line, then, at step 70, changes to the file made by a user served by the owner node will be automatically replicated at the master node, i.e., uploaded to central file storage, so that the updated file is available over the network to other users. If the node is off-line, then the routine branches at step 68 to a subsequent query routine 72 that loops between steps 68 and 70 to check whether network connection is re-established. Connectivity checking may be periodically (e.g., a number of seconds, minutes, or hours) implemented by the satellite node serving the user, or implemented by a polling operation conducted by the master node. As soon as a network connection is re-established, periodic checking or polling ceases and the routine then proceeds to step 70 to replicate the changes in the corresponding file at the master node, as previously explained. Advantageously, enterprise employees whose satellite office owns files can alter them even if connection with the master node is broken, and such changes will automatically and transparently be replicated at the central file storage upon re-establishment of connectivity.

Replication by uploading a remotely edited file may occur periodically on an on-going basis (e.g., seconds or minutes) or may occur when a user completes editing and closes (e.g., stores) the file. If replication occurs prior to closing the file, the file may carry another attribute indicator that notifies a user that editing is “in-progress” thereby locking the file so that users on the network will know this fact.

Based on the illustrated embodiments, a number of variations and alternative embodiments may come to those skilled in the art. Operations performed may occur at various locations over the network and need not be limited to those described in the illustrated embodiments. The illustrated method may include or be embodied within other data processing operations. Accordingly, the invention is not limited to the illustrated embodiments but includes such variations and alternatives that come within the scope of the appended claims.

1. A method of maintaining an updated version of a shared file in a multi-user document management system having a master node and at least one satellite node that communicate over a network, said method comprising the steps of:
providing a central file storage on the network to store a commonly accessible file,
providing ownership information that identifies an owner of the file,
enabling the owner to authorize changes to said file according to the ownership information,
replicating changes to the file at said central file storage,
enabling the owner to transfer ownership of said file by altering the ownership information to identify a subsequent owner who may authorize changes to said file, and
providing shared access to the file via a satellite node communicating over the network with said central file storage whereby to maintain an updated version of the file when multiple users may be authorized to make changes.

2. The method according to claim 1, wherein, in said first providing step, said master node provides access to said central file storage.

3. The method according to claim 1, wherein said owner comprises one of said master and satellite nodes.

4. The method according to claim 1, wherein said enabling step includes said master node providing negotiation for transfer of file ownership between the owner and said subsequent owner.

5. The method according to claim 1, wherein the last providing step includes enabling read-only access to said file when the owner is unavailable to participate in negotiation for transfer of ownership of said file.

6. The method according to claim 1, and further including the steps of enabling a file owner to authorize changes to said file while off-line and replicating said changes upon re-establishment of connection with said network.

7. A method of transferring ownership and editing authority of a file among multiple owner nodes of a network in a multi-user document management system, said method comprising:
providing shared access to a file having associated ownership indicia to identify an owner node of said file and whether ownership of the file may be transferred to another owner node,
transferring ownership and editing authority of the file to another owner node according to said ownership indicia,
enabling an owner node to authorize changes to the file by a user, and
replicating changes to the file at a central file store located on the network to thereby maintain a current version of the file in a multi-user environment that enables changes by multiple users.

8. The method according to claim 7, and further including enabling the owner node to authorize changes to the file while off-line from the network and replicating said changes upon re-establishment of network connection.

9. The method of claim 8, and further including the step of periodically replicating changes to the file in the central file store as changes are being made by a user.

10. The method of claim 7, and further including the step of providing read-only access to said file when network communication with the owner node of the file is broken.

11. A document management system to maintain an updated version of a file accessible by multiple users over a network, said system comprising:
a central file store that stores a file having associated ownership indicia to identify an owner and authorized editor of the file;
at least one satellite node to enable a user on the network to communicate with said central file store in order to store and retrieve files; and
a processor that includes an editing module to enable changes to said file according to said ownership indicia, a replicator module to replicate changes to said file at said central file store, a negotiator module to enable a transfer of file ownership and editing authority to another owner, and an access coordinator to enable access to said file via the network to thereby enable access to an updated version of the file in a multi-user environment that permits a transfer of editing authority among different owners.

12. The system according to claim 11, wherein said ownership indicia further indicates whether ownership may be freely transferred, and said negotiator module responds to said indicia to transparently transfer file ownership to a subsequent owner.

13. The system according to claim 12, wherein said master node handles ownership transfer negotiation.

14. The system according to claim 11, wherein the central file store is located at a master node that handles access to the central file store by the satellite nodes.

15. The system according to claim 14, wherein the master node permits read-only access to said file when the owner of the file is off-line or when ownership transfer is not permitted.

16. The system according to claim 11, wherein said ownership indicia is stored among attributes of said file.

17. The system according to claim 11, wherein said ownership indicia is provided by an ownership records database maintained at said central file store.

18. The system according to claim 11, wherein said editing module enables changes to said file while the owner is off-line and said replicator module replicates said changes upon re-establishment of network connection.

19. The system according to claim 11, wherein said replicator module automatically and periodically replicates changes to said file in said central file store.

20. The system according to claim 11, wherein the owner of said file comprises a satellite node and transfer of ownership occurs among multiple satellite nodes.
